(19) United States
(12) Patent Application Publication
(10) Pub. No.: US 2009/0065543 A1
(43) Pub. Date: Mar. 12, 2009

(54) RACK WITH SHELF

(75) Inventor: Gordon D. Bone, Ivins, UT (US)

Correspondence Address: Workman Nydegger;1000 Eagle Gate Tower, 60 East South Temple, Salt Lake City, UT, 84111, US

(73) Assignee: EXTREME FORM PRODUCTS, LLC, Ivins, UT (US)

(21) Appl. No.: 11/851,315

(22) Filed: Sep. 6, 2007

(51) Int. Cl. B60R 9/00

(52) U.S. Cl. 224/500; 211/85.7; 224/310; 224/42.32; 224/564

(57) ABSTRACT

A rack for a truck or trailer bed includes a shelf configured to be attached to and span between walls of the bed. The shelf is sized to accommodate a set of tires from a recreational vehicle and arranged to position the recreational vehicle on an incline relative to the bed. At least one ramp is attached to the shelf. The ramp is configured to slope downward from the shelf to the bed.

### CROSS-REFERENCE TO RELATED APPLICATIONS

Not applicable.

### BACKGROUND OF THE INVENTION

1. The Field of the Invention

The present disclosure generally relates to a rack for carrying items on truck and trailer beds and, more particularly, to a rack with a shelf to support recreational vehicles.

2. The Relevant Technology

Truck beds and trailers are typically used to haul dirt bikes, sport bikes, ATVs, cruisers, or other small recreational vehicles. The vehicles are loaded into the truck or trailer beds by driving them up a ramp. Once the vehicles are in the bed and situated, they are tied down to the bed using tie straps or chains to prevent the vehicle from falling out of or shifting in the bed while in transit. If a truck bed is not long enough to fit a particular vehicle, the tailgate is left in an open position to accommodate the extra length. Some products have been designed to fence in or extend the tailgate to contain longer recreational vehicles. When the tailgate is open, however, it is difficult to access the trailer hitch and climb into the back of the truck.

Storage space often becomes tight when hauling ATVs in the back of a truck. The ATV or other recreational vehicle consumes most of the space in the bed leaving little or no room for other gear, such as coolers, camping equipment, spare parts, protective gear, and the like. Some equipment can be placed around the vehicle but it usually ends up being stacked or tucked into small areas that are difficult to access and negotiate. If the equipment is not stored properly, it can fall out of the truck bed or damage the recreational vehicle.

Some racks have been developed to load two ATVs side by side on the back of a truck bed and provide storage space under the rack. These racks provide a structure over the top of the bed to haul the vehicles horizontally, side by side. By hauling the vehicles above the bed, however, it raises the center of gravity making it hard to handle the truck, in particular around corners. This increased center of gravity could be dangerous for those hauling the recreational vehicles.

The subject matter claimed herein is not limited to embodiments that solve any disadvantages or that operate only in environments such as those described above. Rather, this background in only provided to illustrate one exemplary technology area where some embodiments described herein may be practiced.

### BRIEF SUMMARY OF THE INVENTION

In one aspect of the invention, a rack for a truck or trailer bed includes a shelf configured to be attached to and span between walls of the bed. The shelf is sized to accommodate a set of tires from a recreational vehicle and arranged to position the recreational vehicle on an incline relative to the bed. At least one ramp is attached to the shelf The ramp is configured to slope downward from the shelf to the bed.

In another aspect of the invention, a rack includes a shelf having a support layer and attachment members. The shelf is arranged to be installed in a substantially horizontal position with the support layer on top and spaced above a surface to provide a storage space below the shelf The attachment members are attached to opposite sides of the shelf and configured to support the shelf The attachment members are configured to span between support structures. The shelf is sized to support one end of a recreational vehicle on the shelf and the other end of the recreational vehicle below the shelf and above the surface. A set of ramps are attached to the shelf Each ramp is configured to slope downward from the shelf to the surface.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a perspective view of a rack installed in a truck bed in accordance with an embodiment of the invention;

FIG. 2 is a detailed view of the rack illustrating the attachment to a wall or structure in accordance with the various embodiments of the invention;

FIG. 3 is a detailed perspective view of the rack illustrating various components in accordance with an embodiment of the invention;

FIG. 4 is a perspective view of another embodiment of the rack;

FIG. 5 is a detailed perspective view of the rack illustrating various components in accordance with an embodiment of the invention;

FIG. 6 is a detailed perspective view of the rack illustrating a one side of a splice in accordance with another embodiment of the invention; and

FIG. 7 is a detailed perspective view of the rack illustrating another side of a splice in accordance with another embodiment of the invention.

### DETAILED DESCRIPTION OF THE VARIOUS EMBODIMENTS

The present systems and methods include various embodiments of a rack with a shelf The rack is configured to store one or more vehicles on the bed of a truck or trailer in an inclined position. The rack includes a shelf and a set of ramps. The shelf attaches to the truck or trailer bed by attaching to and spanning across walls or beams affixed to the bed. Typically, the walls and/or beams are part of the truck or trailer. If the bed is not equipped with the required support, structures can be added to the truck or trailer bed for the rack. The rack can be made of steel, aluminum, composite, plastic members, or similar materials. The members can be welded, formed, molded, or affix using adhesive, ties, or the like or using a combination of these methods of affixing members together.

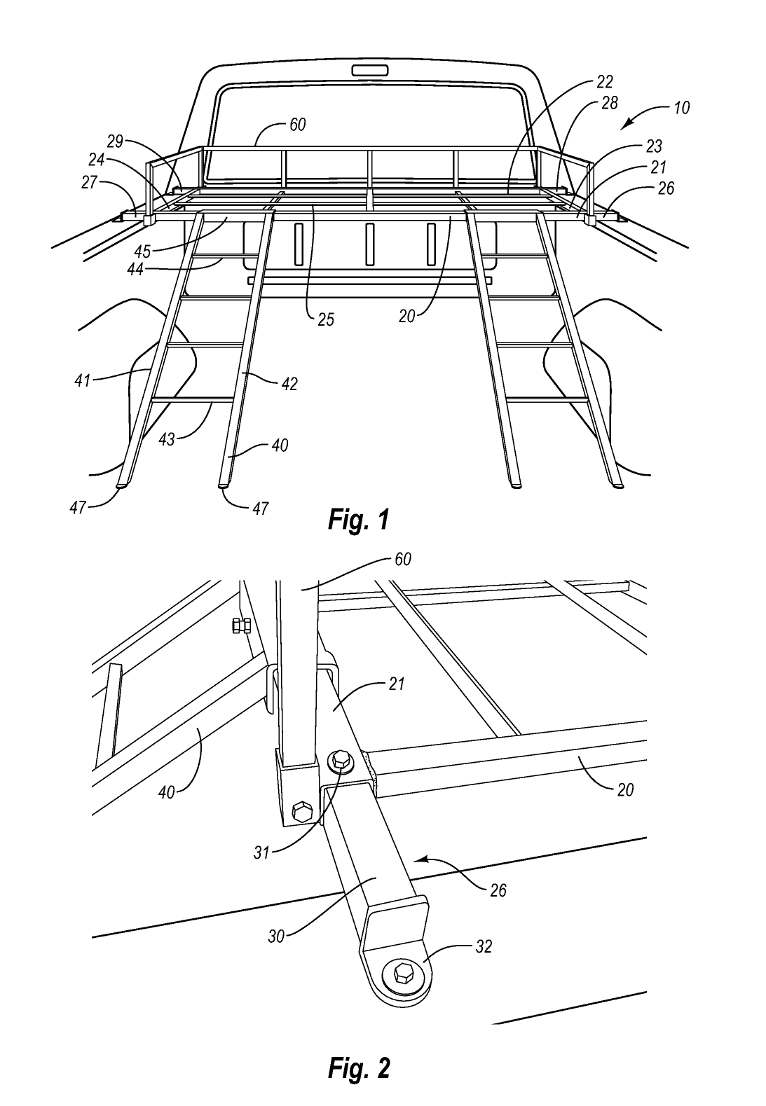

Now turning to the figures, FIG. 1 illustrates a front view of a rack with a shelf in accordance with an embodiment of the invention. The rack 10 is shown assembled to a truck bed, although the rack can also be attached to other flat surfaces, such as a trailer bed, vehicle storage compartments, and the like. The rack 10 includes a shelf 20, a set of ramps 40, 50 and railing 60.

The rack 10 is attached to the truck bed by attaching the shelf 20 to the walls of the bed. The shelf 20 includes two attachment members 21, 22, which are spaced apart by two lateral support members 23, 24. The attachment members 21, 22 are attached to opposite sides of the shelf 20 and configured to support the shelf 20. The attachment members are configured to span between support structures, such as the walls of a truck bed or trailer. A support layer 25 is placed between the attachment members 21, 22 and the lateral support members 23, 24. The support layer 25 is arranged to bear a portion of the weight of the recreational vehicle when it is positioned on the rack 10. The support layer 25, for example, can include checkered plate, webbing, cross beams, mesh material, rigid sheet, struts, or other layer known by one skilled in the art to support an object on a shelf-like structure (see also FIG. 4 discussed below). In one example, the support layer 25 includes ⅝ inch tube stiffeners that span the width and length of the shelf, the stiffeners being arranged in a crisscross pattern.

The first attachment member 21 includes adjustable ends 26, 27, and the second attachment member 22 includes adjustable ends 28, and 29. The adjustable ends 26-29 slide in and out from the attachment members 21, 22 to lengthen or shorten its length, or adjust the length of the attachment members 21. The adjustable ends 26-29 can be configured to slide and be fixed at a desired point relative to the attachment members 21, 22. The adjustable ends 26-29 can be configured to adjust the length of the attachment members 21, 22 to accommodate various distances between the truck or trailer bed, or between some other support structures. If the bed is wider, the adjustable ends 26-29 can be adjusted to lengthen the attachment members 21, 22 to match the bed width. If the bed is shorter, the adjustable ends 26-29 can be adjusted to shorten the attachment members 21, 22. Each adjustable end 26-29 is adjustable with a reach of about 6 inches, providing about 12 inches total of adjustablility for the shelf 20.

The function and structure of each adjustable end 26-29 are similar. For the purpose of simplifying the discussion, adjustable end 26 will be discussed in greater detail below. It shall be known by one skilled in the art that the other adjustable ends 27, 28, and 29 will include similar features and structures described herein.

In one embodiment of the present invention shown in FIG. 2, the adjustable end 26 includes a member 30, such as a tube, pipe, beam, plate, or bar. The member 30 is configured to slide relative to the attachment member 21. For example, the member 30 and the attachment member 21 are made from square tubes, the square tube of the member 30 being sized to have a smaller outer width and height than the inner width and height of the attachment member 21. The tube in this example can be a 1½ inch tube for the attachment member and 1¼ inch tube for the member 30. The member 30 can be arranged to slide into the attachment member 21. A fastener 31, such as a lag bolt, self-tapping screw, bolt or pin is placed through a hole in the attachment member 21 and into the member 30 to fix a desired position of the member 30 relative to the attachment member 21. For example, one end of the member 30 can extend into the attachment member 21 about 3 inches to about 12 inches.

The opposite end of the member 30 includes a fastening device 32, such as a clamp, bracket and fastener, and the like. The fastening device 32 is affixed to the bed wall to hold the shelf 20 in place. In one example, the fastening device 32 includes a tab welded to the end of the member 30, with an aperture formed in the tab and a bolt placed through the hole in the tab and fastened with a nut to attach the member 30 to the wall of the bed. The adjustable ends 26-29 can be configured to interchange between an adjustment position and a locked position. In the adjustment position, the adjustable ends 26-29 are capable of moving relative to the attachment members 21, 22. In the locked position, the adjustable ends 26-29 are fixed at a desired point relative to the attachment members 21, 22.

A set of ramps 40, 50 attach to the shelf 20. Each ramp is configured to slope downward from the shelf 20 to the surface, such as a truck or trailer bed. The ramps 40, 50 are similar in size and shape. The rack 10 can include 1 to 4 ramps in a truck bed application, and can include more ramps for a trailer depending on the size of the trailer. In one example, the ramp 40 includes sidepieces 41, 42 and rungs or crosspieces 43, 44. The ramp can be shaped like a ladder with the crosspieces 43, 44 being intermittently spaced between the sidepieces 41, 42. The ramp can also be formed from plate, such as a metal sheet or checkered floor plate that is bent or reinforced at the edges.

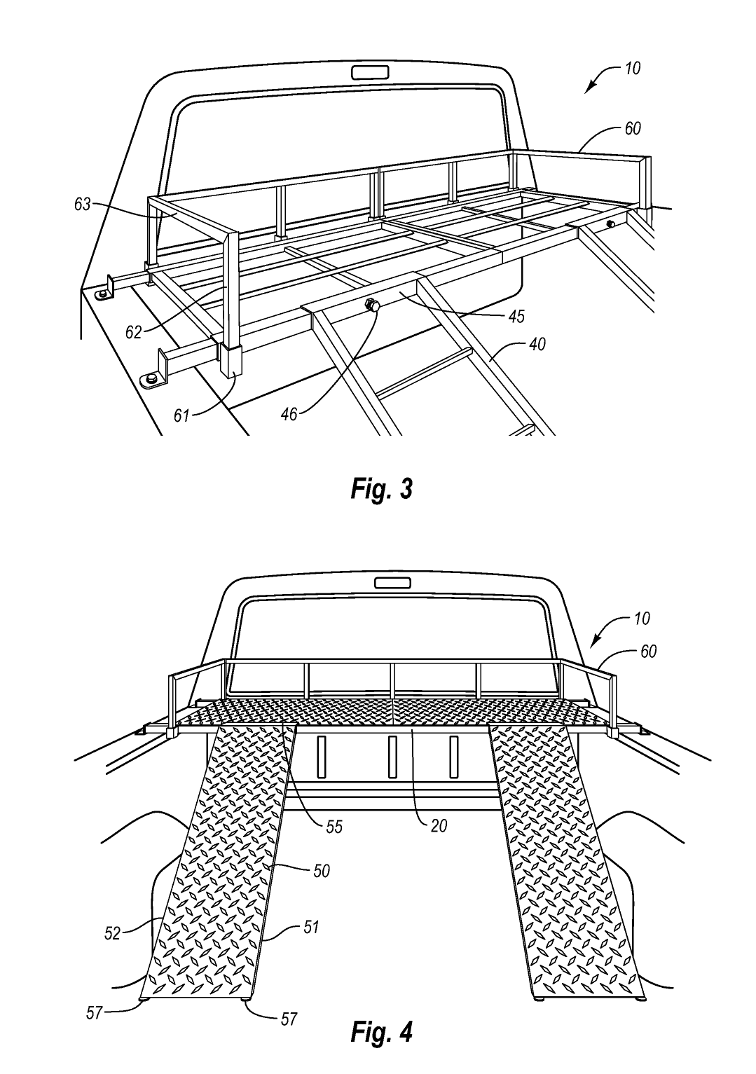

As shown in FIG. 3, one end of the ramp 40 includes a hook mechanism 45 that is configured to connect to an attachment member 21 of the shelf 20. The hook mechanism 45 is attached to one end of the ramp 40 and is shaped to wrap around the attachment member 21, which can be in the shape of a C-channel, J-hook, angle, and the like. The hook mechanism 45 can be configured to slide onto the attachment member 21. The hook mechanism 21 can attach to, slide along, or be removed from the attachment member 21 to position and reposition the ramp 40 along one side of the shelf 20. The spacing of the ramps can be arranged to match the wheelbase of the recreational vehicle being placed on the rack 10.

A locking mechanism 46 can be attached between the ramp 40 and the attachment member 21 to lock the ramp 40 in place once the desired ramp spacing is found. The locking mechanism 46 is configured to lock the ramp 40 in place relative to the attachment member 21. The locking mechanism 46 can include a clamp, pin, bolt, wedge, latch, and the like. For example, the locking mechanism 46 can include a nut that is affixed to the hook mechanism 45 and a bolt that is threaded into the nut until the end of the bolt presses against the attachment member 21 to hold the ramp 40 at a desired place along the shelf 20.

The ramp 40 can also include feet 47 on an end opposite the hook mechanism 45. The feet 47 are arranged to rest on a surface, such as the bed of the truck or trailer, and can include grip, such as a plastic or rubber grip, that frictionally grip to the surface. In one example, each foot 47 is attached to the end of the sidepieces 41, 42. If a plate is used in the ramp 40, the feet 47 can be spaced, or one foot 47 can be placed, along the end of the plate.

FIG. 4 illustrates the rack 10 having another embodiment of a ramp 50. The ramp 50 can also include the same features and components described above with respect to ramp 40. For instance, ramp 50 can include sidepieces 51, 52, crosspieces 53, 54, a hook mechanism 55, locking mechanism 56, and feet 57. Each of these components 51-57 are arranged similar to components 41-47, respectfully. FIG. 4 also illustrates the shelf 20 including a support layer 25 made of a sheet, such as checkered floor plate or diamond plate.

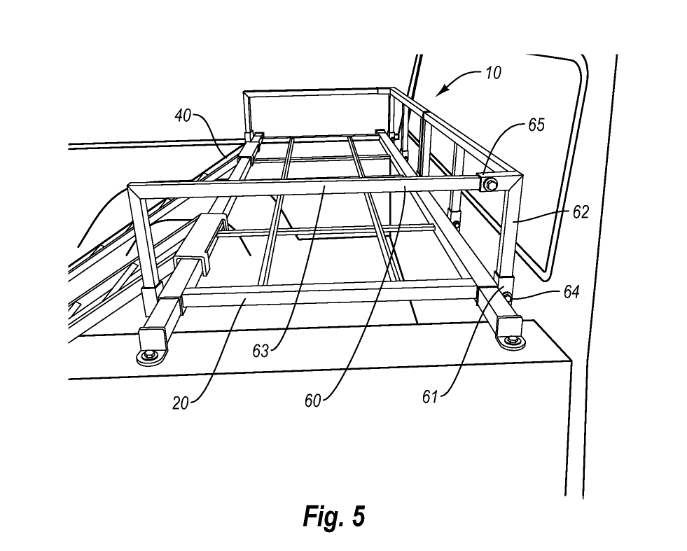

As shown in FIG. 5, a railing 60 can be placed around the shelf 20 to protect the cab of the truck and/or prevent the recreational vehicle from accidentally falling off the shelf 20 when attached to a truck or trailer bed. The railing 60 includes receivers 61 attached around the shelf 20 at desired locations. For example, the rack 10 can include ten receivers 61, two attached to the front side at opposite ends of the shelf 20 and six receivers 61 spaced along the back side of the shelf 20. The railing 60 can be attached to at least one side of the shelf 20, which can be a side of the shelf 20 opposite the ramp 40, three sides of the shelf 20, or around the sides of the shelf 20 other than the side with the set of ramps.

The railing 60 also includes posts 62 and a top rail 63. The posts 62 are spaced to line up with and be inserted into the receivers 61. The posts 62 are sized and spaced to provide support for the top rail 63. The top rail 63 and posts 62 are arranged to prevent the recreational vehicle from progressing beyond the railing 60. The railing 60 can include multiple posts 62 to support the railing 60. The amount of posts 62 depends on the spacing and rigidity of the material and shape of the posts 62. The posts 62, for instance, can be made from a tube, bar, pipe, beam, and the like, and can be steel, aluminum, graphite, polyethylene, or other metal, composite or plastic materials.

Each of the posts 62 are attached to the receivers 61 using a securing device 64. The receivers 61 are designed to accept the posts 62 and are adapted to accommodate the securing device 64, which locks each of the posts 62 to a respective receiver 61. The securing device 64 can include a bolt and nut, screw, pin, spring loaded or quick release pin, snap-fit connection, clamp, or any other device know by one skilled in the art to secure a post to a receiver. In one example, the post 62 is inserted into the receiver 61 and the securing device 64 includes a bolt that passes through a hole aligned through the post 62 and receiver 61. One end of the hole can be threaded or a nut can be attached to the end of the bolt. The bolt and nut provide a securing device 64 to hold the railing 60 in place.

The railing 60 can be broken down into even smaller components when the top rail 64 is spliced at certain points. The top rail 64, for example, can include a joint 65 to splice together two or more sections of the railing 60. In one example, the joint 65 includes pieces of the top rail 64 that fit into each other. One end of the piece can have a smaller outer size than the inner size of other end of the top rail 64. The smaller piece can then fit into the larger piece to form the joint 65. The joint can include a fastener, such as a pin, bolt, rivet, screw, spring loaded or quick release pin, snap-fit connection, and the like, to secure the pieces of the joint together.

As known by one skilled in the art, the railing 60 can be divided into smaller pieces or can be made to be one piece, or also attached directly to the shelf 20 without requiring the receivers 61. By providing receivers 61, however, it is easier for users to assemble the railing 60 to the shelf 20. And the rack 10 is easier to handle and ship when it is made with detachable components that can be broken down into smaller pieces.

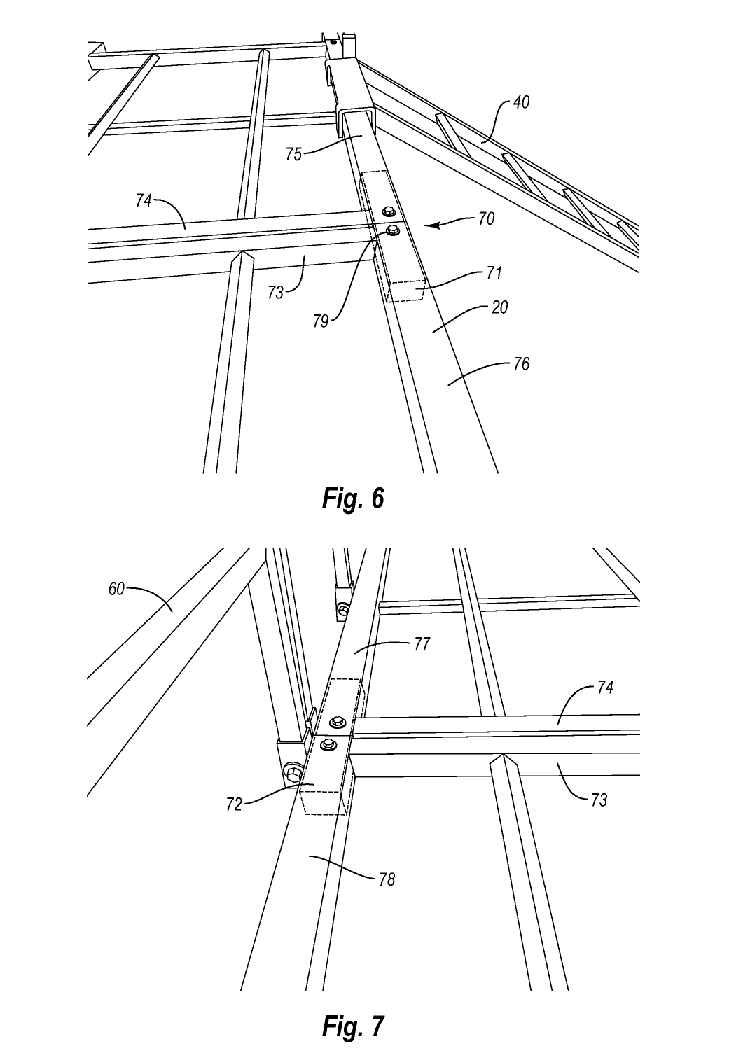

The shelf 20 may also be broken down into one or more pieces with a splice 70 as illustrated in FIGS. 6 and 7. The splice 70 includes reinforcing members 71, 72 and lateral supports 73, 74. The attachment members 21, 22 are cut at a desired location to divide the shelf 20 into separate components, such as attachment member pieces 75, 76, 77, 78. The lateral supports 73, 74 are attached to the cut ends of the attachment members 21, 22 to make shelf sections with the attachment member pieces 75-78, lateral support members 23, 24 and lateral supports 73, 74.

The reinforcement member 71 is placed between the attachment member pieces 75, 76 and reinforcement member 72 between attachment member pieces 77, 78 by sliding the reinforcement members 71, 72 inside the attachment member pieces 75-78. The reinforcement members 71, 72 are sized to fit inside the attachment member pieces 75-78 with a tight fit to prevent rotational play between the attachment member pieces 75-78 when assembled. Once the reinforcement members 71, 72 are installed, they are held in place with fasteners 79, such as self tapping screws, bolts, pins, and the like. The fasteners 79 attach the reinforcement members 71, 72 to the attachment member pieces 75-78.

To assemble the rack 10, the shelf 20 is attached to the bed of a truck or trailer using the fastening device 32. The user may be required to drill holes in the bed wall if the fastening device 32 requires a hole, for example, when bolts are used. If the shelf 20 includes a splice 70, the reinforcing members 71, 72 are inserted into the attachment member pieces 75-78 and fastened down with fasteners 79. The shelf 20 can be shifted at the adjustable ends 26, 27, 28, 29 until the shelf 20 is aligned properly in the bed. Once the shelf 20 is aligned to a desired position, the adjustment ends 26-29 are fixed using the fastener 31.

The ramp 40 is installed by placing it on the shelf 20. The hook mechanism 45 is inserted over the attachment member 21 and moved to a desired location relative to a wheelbase of a recreational vehicle or spacing between recreational vehicles. The ramp 40 is then locked in place using the locking mechanism 46. Other ramps can be added and installed as needed in a similar manner.

The railing 60, if not permanently attached, can be installed to the shelf 20 by placing the posts 62 in the receivers 61. Users can first lay out the railing 60 in the proper locations so that the posts 62 are placed in the proper receivers 61. The posts 62 are affixed to the receivers 61 with the securing device 64. If the top rail 63 is split into separate pieces, the top rail can be connected together at the joint 65 to secure the top rail 63 around the railing 60.

The rack 10 is generally installed in a horizontal position or substantially parallel to the bed. The ramp 40 is arranged to extend at an angle from the shelf 20 downward to the bed. The angle between the top of the bed and the backside or underside of the ramp 40 can vary depending on the offset of the shelf 20 from the bed and the length of the ramp 40. In the various examples, the angle can be about 30 degrees to about 60 degrees, and more particularly, about 45 degrees. The angle of the ramp 40 is designed to provide a way to drive the recreational vehicle up to the shelf 20.

The recreational vehicle is positioned to place one set of tires on the ramp while the other set is positioned on the bed of the ramp 40 depending on the length of the wheelbase. This arrangement places the recreational vehicle at an angle relative to the bed to reduce the amount of space the vehicle takes up on the bed and provide storage space under the shelf 20. The shelf 20 can be installed in a substantially horizontal position with the support layer 25 on top and spaced above a surface, such as a truck or trailer bed, to provide a storage space below the shelf 20. The shelf 20 is sized to support one end of a recreational vehicle on the shelf 20 and the other end of the recreational vehicle at a point below the shelf 20 and above the surface, for example, on the ramp 40 or truck or trailer bed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A rack for a truck or trailer bed, comprising:
a shelf configured to be attached to and span between walls of the bed, the shelf being sized to accommodate a set of tires from a recreational vehicle and arranged to position the recreational vehicle on an incline relative to the bed; and
at least one ramp attached to the shelf, the ramp being configured to slope downward from the shelf to the bed.

2. The rack according to claim 1, further comprising a railing attached to at least one side of the shelf.

3. The rack according to claim 2, wherein the railing is attached to a side of the shelf opposite the ramp.

4. The rack according to claim 2, wherein the railing is attached to three sides of the shelf.

5. The rack according to claim 1, wherein the shelf includes attachment members having adjustable ends, the adjustable ends being configured to adjust the length of the attachment members.

6. The rack according to claim 5, wherein adjustable ends are configured to slide relative to the attachment members and be fixed at a desired point relative to the attachment members.

7. The rack according to claim 1, wherein the ramp includes a hook mechanism, the hook mechanism being configured to connect to an attachment member.

8. The rack according to claim 7, wherein the hook mechanism is attached to one end of the ramp and is shaped to wrap around the attachment member.

9. The rack according to claim 8, wherein the ramp includes feet attached to an end opposite the hook mechanism, the feet being configured to rest on the bed.

10. The rack according to claim 1, further comprising a locking mechanism attached between the ramp and the attachment member, the locking mechanism being configured to lock the ramp in place to the attachment member.

11. A rack, comprising:
a shelf including a support layer and attachment members, the shelf being arranged to be installed in a substantially horizontal position with the support layer on top and spaced above a surface to provide a storage space below the shelf, the attachment members attached to opposite sides of the shelf and configured to support the shelf, the attachment members being configured to span between support structures, the shelf being sized to support one end of a recreational vehicle on the shelf and the other end of the recreational vehicle below the shelf and above the surface; and
a set of ramps attached to the shelf, each ramp being configured to slope downward from the shelf to the surface.

12. The rack according to claim 11, further comprising a railing attached around the sides of the shelf other than the side with the set of ramps.

13. The rack according to claim 1, wherein the attachment members of the shelf include adjustable ends, the adjustable ends being configured to adjust the length of the attachment members to accommodate various distances between the support structures.

14. The rack according to claim 13, wherein adjustable ends are configured to interchange between an adjustment position and a locked position, in the adjustment position the adjustable ends being capable of moving relative to the attachment members and in the locked position the adjustable ends being fixed at a desired point relative to the attachment members.

15. The rack according to claim 1, wherein the ramp includes a hook mechanism attached to one end of the ramp, the hook mechanism being configured to slide onto the attachment member.

16. The rack according to claim 15, wherein the ramp includes feet, the feet being configured to rest on the surface and attach to the ramp on an end opposite the hook mechanism.

17. The rack according to claim 11, wherein the ramp includes feet, the feet being configured to rest on the surface.

18. The rack according to claim 17, wherein the feet include grips to frictionally grip to the surface.

19. The rack according to claim 11, further comprising a locking mechanism attached between the ramp and the attachment member, the locking mechanism being configured to lock the ramp in place relative to the attachment member.
